(19) United States
(12) Patent Application Publication
(10) Pub. No.: US 2009/0006110 A1
(43) Pub. Date: Jan. 1, 2009

(54) SYSTEM AND METHOD FOR MONITORING EVENT PARTICIPATION

(76) Inventors: Kristina S. Beckley, Carlisle, MA (US); Pamela A. Nesbitt, Tampa, FL (US); Christopher D. Price, Georgetown, KY (US); Amy D. Travis, Arlington, MA (US); Lorin E. Ullmann, Austin, TX (US)

Correspondence Address: HOFFMAN WARNICK LLC, 75 STATE STREET, 14TH FLOOR, ALBANY, NY, 12207, US

(21) Appl. No.: 11/771,021

(22) Filed: Jun. 29, 2007

(51) Int. Cl. G06Q 10/00

(52) U.S. Cl. 705/1

(57) ABSTRACT

The invention provides a system and method for monitoring event participation.

### TECHNICAL FIELD

The invention relates generally to attendance management and more particularly to monitoring participation in an event based on an event agenda and/or an event presentation.

### BACKGROUND OF THE INVENTION

Monitoring an individual's attendance at a meeting or other event often involves manually taking the attendance of those present or relying on automated methods of tracking when an individual joined and left the event. Given the dynamic nature of many meetings and presentations, it is not possible to determine whether a particular individual was present for a critical portion of the meeting or presentation using such methods. That is, since the critical portion may be presented at a time that cannot be reliably determined in advance, known methods do not enable a determination of whether a particular individual was present at the meeting or event at the time the critical portion was presented.

Accordingly, there exists a need in the art to overcome the deficiencies and limitations described hereinabove.

### SUMMARY OF THE INVENTION

The invention provides a system and method for monitoring event participation.

A first aspect of the invention provides a computer-implemented method of monitoring an individual's participation in an event, comprising: establishing at least one participation criterion; associating the at least one participation criterion with at least one of the following: an event agenda; and an event presentation; monitoring an individual's attendance at the event; determining whether the individual's attendance satisfies the at least one participation criterion; and reporting whether the individual's attendance satisfies the at least one participation criterion.

A second aspect of the invention provides a system for monitoring an individual's participation in an event, the system comprising: a system for establishing at least one participation criterion; a system for associating the at least one participation criterion with at least one of the following: an event agenda; and an event presentation; a system for monitoring an individual's attendance at the event; a system for determining whether the individual's attendance satisfies the at least one participation criterion; and a system for reporting whether the individual's attendance satisfies the at least one participation criterion.

A third aspect of the invention provides a program product stored on a computer-readable medium, which when executed, monitors an individual's participation in an event, the program product comprising: program code for establishing at least one participation criterion; program code for associating the at least one participation criterion with at least one of the following: an event agenda; and an event presentation; program code for monitoring an individual's attendance at the event; program code for determining whether the individual's attendance satisfies the at least one participation criterion; and program code for reporting whether the individual's attendance satisfies the at least one participation criterion.

The illustrative aspects of the present invention are designed to solve the problems herein described and other problems not discussed, which are discoverable by a skilled artisan.

### BRIEF DESCRIPTION OF THE DRAWINGS

These and other features of this invention will be more readily understood from the following detailed description of the various aspects of the invention taken in conjunction with the accompanying drawings that depict various embodiments of the invention, in which:

FIG. 1 shows a block and flow diagram of an illustrative method according to the invention.

It is noted that the drawings of the invention are not to scale. The drawings are intended to depict only typical aspects of the invention, and therefore should not be considered as limiting the scope of the invention. In the drawings, like numbering represents like elements between the drawings.

### DETAILED DESCRIPTION OF THE INVENTION

As indicated above, the invention provides a system and method for monitoring participation in an event based on an event agenda and/or an event presentation.

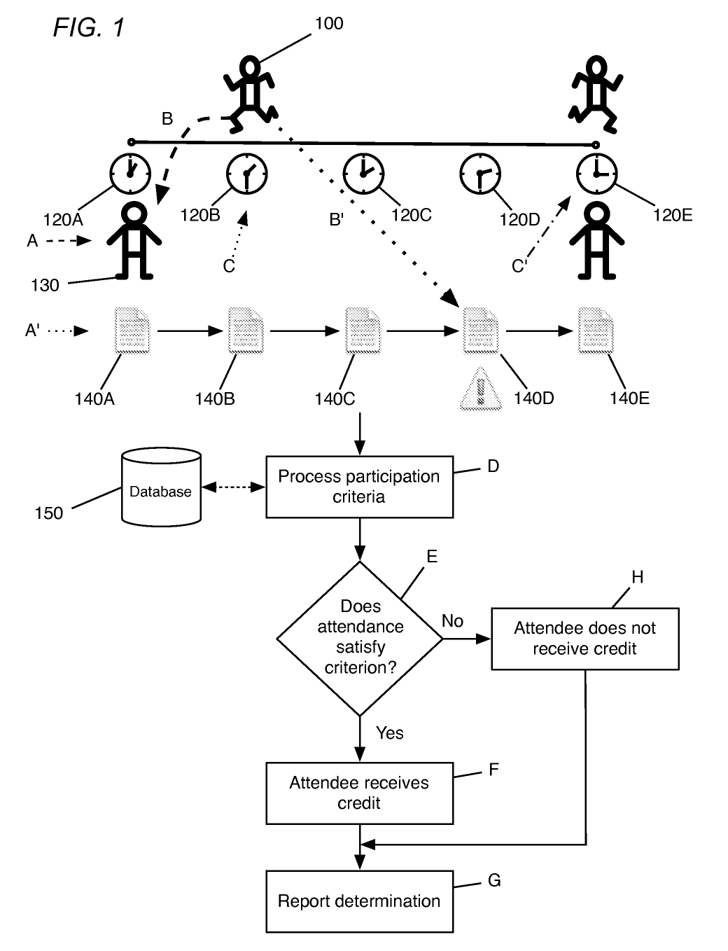

FIG. 1 shows a block and flow diagram of an illustrative method according to one embodiment of the invention. At least one participation criterion is established, by which it will be determined whether an individual 100 receives “credit” for his or her participation in an event. At A, the criterion is whether individual 100 was present during the entire period in which a presenter 130 or another (e.g., the individual's boss) was present. Alternatively, or in addition, the criterion at A′ is whether individual 100 was present during the presentation of a pre-defined item 140D during the presentation. That is, item 140D and/or the attendance of presenter 130 is electronically linked or otherwise associated B′ and B, respectively, with the attendance of individual 100. The arrival C and departure C′ of individual 100 may be monitored in any number of ways, including the use of known electronic attendance monitors described above.

At D, the criterion or criteria established above is/are processed (e.g., arrival and departure times determined). Such processing may include retrieval of data from and/or transfer of data to a database 150. Database 150 may be used not only for the storage of data related to the current event, but also for the storage of data from previous events, which may be useful for compliance monitoring, auditing, and self-governance.

At E, it is determined whether the attendance of individual 100 satisfies the criterion established at A and/or A′. For example, as shown in FIG. 1, presenter 130 attended the event from 1:00 120A until 3:00 120E. Individual 100 attended the event only from 1:30 120B until 3:00 120E. Thus, if the criterion for determining whether individual 100 receives credit for his/her attendance is established according to A above (i.e., whether individual 100 was present for the entire period that presenter 130 was present), the criterion is not met (i.e., “No” at E) and individual 100 would not receive credit at H.

If, on the other hand, the criterion is established according to A′ above (i.e., whether individual 100 was present for the presentation of item 140D), the criterion is met (i.e., “Yes” at E) and individual 100 would receive credit at F. In either case, the determination made at E may be reported at G.

In other embodiments of the invention, a criterion may include for example, pre-defined arrival and/or departure times, pre-defined total attendance times, or combinations thereof. In still other embodiments of the invention, an individual's attendance may be compared to a meeting or presentation agenda, the agenda including pre-defined flags for tracking the completion of particular agenda items. In such an embodiment, the present invention may be used not only for monitoring an individual's attendance to determine whether such attendance satisfies a criterion necessary to receive attendance “credit,” but may also be used to determine whether the meeting or presentation met compliance requirements by establishing whether all agenda items were presented.

Some or all aspects of the present invention can be provided on a computer-readable medium that includes computer program code for carrying out and/or implementing the various process steps of the present invention, when loaded and executed in a computer system. It is understood that the term “computer-readable medium” comprises one or more of any type of physical embodiment of the computer program code. For example, the computer-readable medium can comprise computer program code embodied on one or more portable storage articles of manufacture (e.g., a compact disc, a magnetic disk, a tape, etc.), on one or more data storage portions of a computer system, such as memory and/or a storage system (e.g., a fixed disk, a read-only memory, a random access memory, a cache memory, etc.), and/or as a data signal traveling over a network (e.g., during a wired/wireless electronic distribution of the computer program code).

It should be appreciated that the teachings of the present invention could be offered as a business method on a subscription or fee basis. For example, a service provider can create, maintain, enable, and deploy an audience response detection interactive presentation tool, as described above.

What is claimed is:

1. A computer-implemented method of monitoring an individual's participation in an event, comprising:
establishing at least one participation criterion;
associating the at least one participation criterion with at least one of the following:
an event agenda; and
an event presentation;
monitoring an individual's attendance at the event;
determining whether the individual's attendance satisfies the at least one participation criterion; and
reporting whether the individual's attendance satisfies the at least one participation criterion.

2. The computer-implemented method of claim 1, wherein monitoring includes monitoring when the individual entered and left the event.

3. The computer-implemented method of claim 1, wherein determining includes determining whether a period of the individual's attendance included at least one of the following:
a period of an additional individual's attendance; and
disclosure of a pre-defined item in the event presentation.

4. A system for monitoring an individual's participation in an event, the system comprising:
a system for establishing at least one participation criterion;
a system for associating the at least one participation criterion with at least one of the following:
an event agenda; and
an event presentation;
a system for monitoring an individual's attendance at the event;
a system for determining whether the individual's attendance satisfies the at least one participation criterion; and
a system for reporting whether the individual's attendance satisfies the at least one participation criterion.

5. The system of claim 4, wherein the system for monitoring includes a system for monitoring when the individual entered and left the event.

6. The system of claim 4, wherein the system for determining includes a system for determining whether a period of the individual's attendance included at least one of the following:
a period of an additional individual's attendance; and
disclosure of a pre-defined item in the event presentation.
